(19) United States
(12) Patent Application Publication
(10) Pub. No.: US 2008/0043259 A1
(43) Pub. Date: Feb. 21, 2008

(54) METHOD AND SYSTEM FOR HARDCOPY OUTPUT OF SNAPSHOTS AND VIDEO

(76) Inventors: Roger Lee Triplett, Penfield, NY (US); John Allott Moore, Webster, NY (US); Adam Emanuel Stein, Rochester, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/465,550

(22) Filed: Aug. 18, 2006

(51) Int. Cl. G06F 15/00; H04N 1/60; G06K 1/00

(52) U.S. Cl. 358/1.9; 382/293

(57) ABSTRACT

A hardcopy display such as a book displays both snapshots and video sequences from a digital camera. The video sequences are printed as individual frames of a video that are aligned and sequence among pages of the book such that when they are flipped in rapid sequence, the action from the video sequence is displayed.

### BACKGROUND

1. Technical Field

The disclosed embodiments generally relate to hardcopy photo books representing digital snapshots and video clips, and methods of making them.

2. Description of the Related Art

The advent of digital photography has increased the possibilities of publishing and sharing memories represented in photographs or snapshots and videos, particularly since today's digital cameras have the ability to take traditional snapshots as well as short segments of video. The notion of a “photo book,” or a hardcopy representation of individual digital images captured by a digital camera, has become a commonplace method for publishing and storing digital snapshots. Personalized photo books are offered by many popular internet-based photo-sharing sites, such as Shutterfly, Snapfish, and Kodak EasyShare Gallery. Users enter these sites and upload digital images onto the site, where the images are stored. Software is used to customize the images onto pages of a photo book according to user commands. The photobook may be customized and personalized through individual selection of page layouts, borders, captions, covers, etc. A photo book does not require a special viewing device, such as a computer, television, or other electronic display software, thus providing a convenient and archival record of digital snapshots. An exemplary system for the acquisition, organization, manipulation, and publication of digital images onto a photo book or other media is described in U.S. Pat. No. 6,850,247, the disclosure of which is incorporated herein by reference in its entirety.

Videos can be stored and viewed in accordance with one of two basic medias: 1) storage in electronic formats, such as VHS, Beta, CD, DVD-RAM, DVD, etc. that require special electronic equipment for viewing, or 2) hardcopy prints of individual frames of a video sequence that are typically printed on the edges of separate pages and can be viewed by physically flipping through the pages in rapid sequence to create the effect of a motion picture, commonly known as “flipbooks.” Electronic video formats rapidly become obsolete as new formats arrive on the market, as can be seen, for example, through the evolution of the market from VHS to DVD in a relatively short period of time (i.e. around 10 years). Moreover, electronic storage media deteriorates over time, and viewing requires additional electronic equipment that is susceptible to typical mechanical failures.

The concept of flipbooks has been around since the beginning of motion pictures. The packaging of video clips into a single historical physical recording of an event provides convenience and eliminates the need for a video player. Video sequences may be preserved and viewed through the use of a flipbook so long as the physical copy of the flipbook remains intact. The flipbook is, therefore, an archival record of a video that never becomes obsolete. It is also more difficult to reproduce a video flipbook than an electronic format video, thus providing an additional level of copyright protection. There are numerous internet-based sites that now offer personalized flipbooks as a method of viewing video clips. See e.g., the websites www.flipclips.com and www.fliptomania.com. One constraint, however, that exists when a series of individual snapshots are presented together for viewing in rapid sequence is the potentially limited number of pages available to view an entire video sequence. Accordingly, a method of interpolating or time scaling a video sequence to fit within the number of pages available is desirable.

Currently there are no convenient, portable, and archival mechanisms for viewing video clips, without electronic display hardware, together with digital snapshots in a single hardcopy output. Accordingly, a method of making a combination photo book and flipbook is desirable, such that, for example, a still photo may be viewed together with a video sequence of an action related to that still photo. The disclosure contained herein describes attempts to address one or more of the problems described above.

### SUMMARY

In an embodiment, a hard copy display, such as a book, includes a plurality of bound pages containing a plurality of snapshots, and a plurality of individual frames of a video sequence. The individual frames are arranged so that when the pages of the display are flipped, the video sequence is displayed. In some embodiments, the display also includes all electronic device that plays audio, such as an EPROM chip and sound synthesizer. In some embodiments, the pages may be cut along the width of the display to create two or more sections, so that each section displays at least one of snapshots, video sequences, and text. In some embodiments, the snapshots may be displayed on pages located opposite pages that display frames from the video sequence. In some embodiments, two or more video sequences may be displayed and may be viewed simultaneously.

In another embodiment, a method of making a hardcopy display that displays images and video sequences on pages includes receiving digital images and a video sequence via an electronic communication system, storing the digital images and video sequence onto a storage device, receiving a selection of a location for the digital images and frames of the video sequence to be displayed on pages in a printed book, printing the digital images and frames of the video sequence in the determined location on the pages, and binding the pages together to create the book. The receiving a selection may include actions such as automatically determining the locations automatically determining size and one or more dimensions for the pages.

In some embodiments, the method may include cutting the paper before binding so that the frames are positioned substantially at edges of the pages. In some embodiments, the number of images in the video sequence may exceed the number of pages to be printed in the book, and the method may then include automatically selecting images from the sequence for printing in the book and automatically selecting images from the sequence that will not be printed in the book. In other embodiments, the number of images in the video sequence may be less than the number of pages to be printed in the book, and the method may then include automatically selecting images from the sequence that will be duplicated or interpolated on successive printed pages in the book. The method also may include comparing a second video frame with a first video frame sequenced before it, and if there are no differences, excluding the second video frame from inclusion in the printed book. The method also may include comparing a video frame with at least one snapshot, and if there are similarities, displaying them on the same page. In some embodiments, the method also may include recording at least one audio segment from the video sequence onto an electronic memory device for inclusion in the printed book.

In an alternate embodiment, a book includes a first set of bound pages displaying a plurality of snapshots, and a second set of bound pages displaying a plurality of individual frames of a first video sequence. The individual frames of the video sequence may be arranged so that when the pages are flipped, the first video sequence is displayed without flipping the pages of the first set. The book also may include a third set of bound pages displaying a plurality of individual frames of a second video sequence, wherein at least a portion of the first and second video sequences may he viewed simultaneously. In some embodiments, the frames of the first sequence may be located on pages opposite the pages containing the frames of the second sequence, and the width of the pages of the first section may be different from the width of the pages of the second section.

### BRIEF DESCRIPTION OF THE DRAWINGS

FIGS. 1A and 1B depict an exemplary embodiment of a hardcopy display.

FIG. 2 depicts another exemplary embodiment of a hardcopy display.

FIG. 3 depicts another exemplary embodiment of a hardcopy display.

FIG. 4 is a flow diagram of a method of creating a hardcopy display.

FIG. 5 is a flow diagram illustrating an exemplary trimming and binding process.

FIG. 6 is a flow diagram of an exemplary layout process.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to,” Unless defined otherwise, all technical and scientific terms used herein have the same meanings as commonly understood by one of ordinary skill in the art. Thus, for example, reference to a “book” is a reference to one or more bound printed publications, such as a paperback book, a hard cover book, a photo album, a magazine, a spiral-bound document, and equivalents thereof known to those skilled in the art, and so forth. Reference to an “image” is a reference to one or more video frames, illustrations, snapshots or analog or digital photographs.

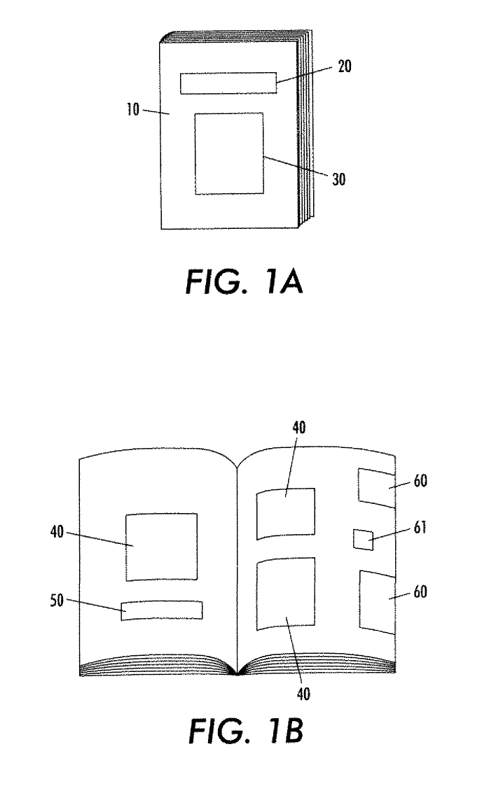

In accordance with one embodiment, as illustrated in FIGS. 1A and 1B, a hardcopy display, such as a book, is shown, where the book displays one or more snapshots and one or more frames from video sequences from a digital camera. FIG. 1A shows that the cover page 10 may include an area for text 20, such as a title, and an area for a snapshot 30. For example, the cover page may include a picture of a bride and groom, with the title “Our Wedding Album.” This is merely an example, however, and the cover page may include any combination of snapshots, text, and video frames, it may be blank, or there may be no cover page at all. Referring to FIG. 1B, when the book is opened, the pages inside may include any combination of snapshots 40, text 50, and/or video frames 60. “Snapshots” may include still photographs, illustrations, or other images that are not presented as part of a video sequence. A set of “video frames” or a “video sequence” will be made up of individual prints of frames of a video that are printed, aligned, and sequenced among the pages the book such that when they are flipped in rapid sequence, the action from a video sequence is displayed. Optionally, “video frames” or a “video sequence” may include a sequence of consecutive still photographs that, when included in a flipbook on pages as a motion sequence, illustrate a sequence of action. In either case, the frames may be printed among every page of the book, or among groups of pages of the book, such that several video sequences may be stored in one hardcopy display and may be viewed at the same or different times. The video frames may be printed on or very close to any edge of the paper, and may be located on or near the left, right, top, or bottom or any combination thereof. The video frames may be printed on every page, alternating pages, or only a portion of the pages of the book, and may be sequenced in reverse order of the book, such that they are viewed by thumbing from the back of the book to the front, or they may be sequenced from front to back.

In some embodiments, video frames presented on a page set may be related to the snapshots that accompany them. Thus, in continuing with the previous example, when the book is opened, the right side of the first page may include a snapshot of the bride and groom at the altar, and the left side may include a snapshot of the bride and groom kissing and a snapshot of them cutting the cake. Next to the “kissing” picture, there may be video frames that, when flipped, depict the bride and groom's first dance that ended with the kiss depicted in the snapshot. Next to the “cake” picture, there may be video frames that, when flipped, depict the bride and groom actually cutting the cake. Optionally, the book may include an electronic memory device for playing audible sounds, such as, for example, an integrated circuit equipped with an erasable-programmable read-only memory (“EPROM”) chip and sound synthesizer 61 that plays audio corresponding to what is displayed on the page. Exemplary electronic memory devices including EPROM chips and sound synthesizers are described in U.S. Pat. No. 5,063,698, and U.S. Pat. No. 4,531,310, the disclosures of which arc incorporated herein by reference in their entirety. The audio may be related to or taken from the video recording, such as, for example, the music from the first dance, or it may be preselected audio such as, for example, an audio recording of the music “Here Comes the Bride” when the page displays a bride walking down the aisle.

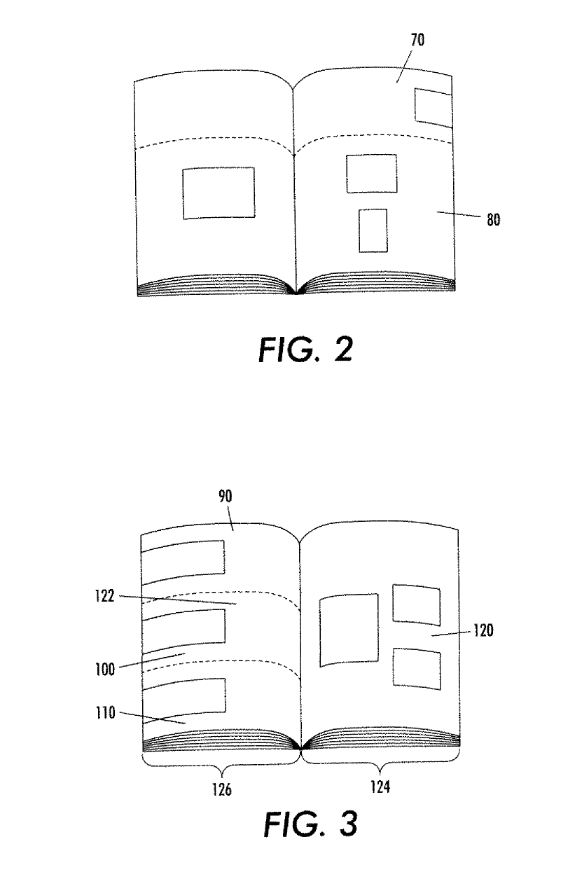

As shown in FIG. 2, the paper within the book may optionally be cut in one or more locations horizontally across the width of the book to divide the book into sections separating the video frame section or sections 70 from the snapshot section or sections 80, such that each video sequence is its own separate flipbook. This allows the video to be viewed without changing the page of the snapshot.

As shown in FIG. 3, the binding of the book may optionally be split according to a type of binding commonly known as a “spline,” such that the snapshots may be viewed on the opposite side of the book 120 as the video frames 122. The video frames may be separated into two or more several separately bound sections 90, 100, 10, that allow for multiple videos to be viewed simultaneously. Optionally, the side containing the snapshots 120 may have a width 124 that is different from, such as larger than or smaller than, the width 126 of the side 122 containing the video frames.

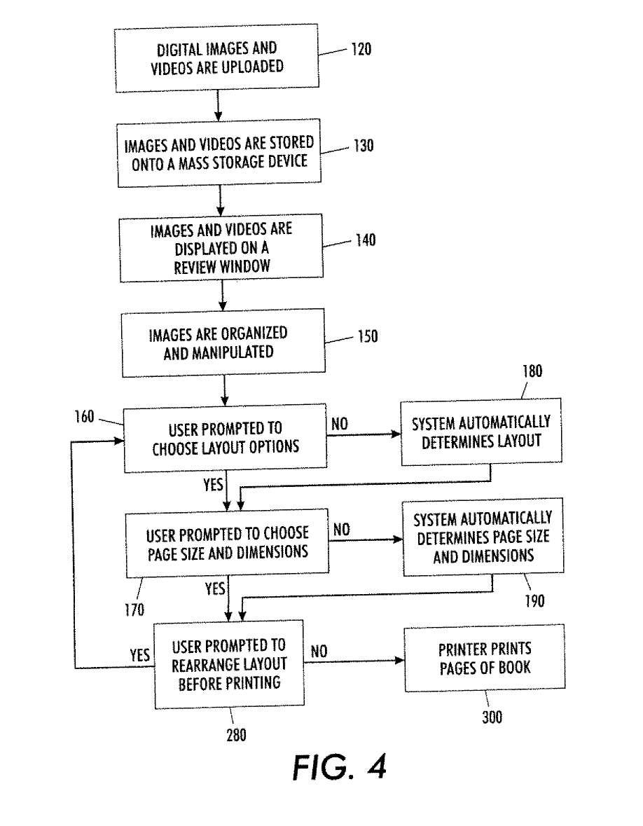

In accordance with another embodiment, as illustrated in FIG. 4, there is shown an overall flowchart illustrating a method of creating a hardcopy display, such as a book, that displays both images and video sequences from a digital camera. In this method, a user uploads digital images and videos onto a host computer system that optionally may include a website 120, wherein the user is empowered to organize and manipulate the acquired images. The acquired images and videos are stored onto a mass storage device 130. Once images and videos have been acquired into the computer system, the system displays the images and videos on a review window 140 such that the user may organize and manipulate the images 150. Organization and manipulation is not required, however. The images may be organized by tagging the images with informative keywords and grouping images into pages for the book. The images may be manipulated by any combination of rotating, cropping, and digitally enhancing for aesthetic purposes.

A main review window allows the user to view all the images and videos that have been acquired in the system. The available digital images and videos may be displayed as thumbnail summary images within the main image review window. The user may scroll through the various images using a scroll bar, and may move and place images in the desired location on each page of the book. The user may be prompted to choose from different layout options for both the images and the video sequences 160, as well as different page sizes and dimensions 170.

Alternatively, the system may automatically determine the number of pages required for the book depending upon the number of images and videos uploaded, and it may automatically place the images in a predetermined layout based upon the number of pages, the size of the pages (if chosen), and the number of images and video frames 180. This may be accomplished through the application of an interpolation or time scaling algorithm that allows the system to evenly fill the pages with the uploaded video sequence or sequences. For example, the system may compare the number of available frames to the number of available pages and either interpolate or extrapolate the sequence using any now or hereafter known method to fill the appropriate number of pages. For example, if a video sequence includes 600 frames and the book has only 60 pages, the system may extrapolate 60 representative frames from the available 600 frames to fill the 60 pages. Other numbers of frames and pages may be used, and not every page must include a frame. The extrapolation in this may simply include using a divisor in this case 10, as available pages equal one-tenth of the available frames, and selecting ever 10^{th} frame for inclusion in the book. Alternatively, the system may use pattern recognition or similar techniques (described below) to reduce the number of available images so that only desired images, such as images that change as the book progresses, are used. On the other hand, if the number of pages exceeds the number of available frames, the system may expand the frames to fill available pages by, for example, duplicating frames on successive pages, or skipping a select number of pages. Other interpolation methods may be used to fill the extra pages or select which pages should not be filled.

If the size of the pages is not pre-chosen by the user, the system may chose a page size depending on an optimal layout or default setting 190. Layout options may include, but are not limited to, the video frames being located on any edge of the paper, at the left, right, top, or bottom or any combination thereof, the book may be divided into sections separating the video fame section or sections from the snapshot image section or sections, such that each video sequence is included in its own separate flipbook; the snapshots may be located on the opposite side of the book as the video frames, which may be separated into two or more separately bound sections that allow for multiple videos to be viewed simultaneously; and the snapshots may be displayed vertically or horizontally in any position on any page of the book.

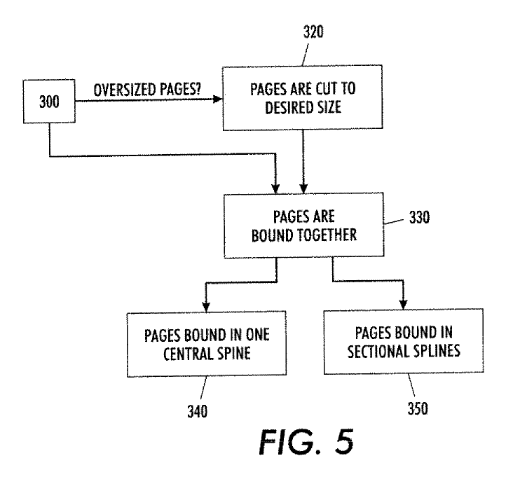

Optionally, the user may be offered an opportunity to rearrange the layout before final printing 280. When the user verifies that the book is ready for printing, a printer prints the pages of the book on the appropriate page size 300. In one optional embodiment, as illustrated in FIG. 5, the printer prints the pages on oversized paper, and the paper is cut to the desired size 320 before the pages are bound together 330. This permits video frames to be printed on a sheet of paper at a location other than the edge of the sheet, while the cutting or finishing step causes the video image to be precisely located at a desired location at or near the edge of the sheet. The pages may all be bound together into one book with one central spine 340, or different sections may be bound separately with bindings commonly referred to in the art as “splines” 350.

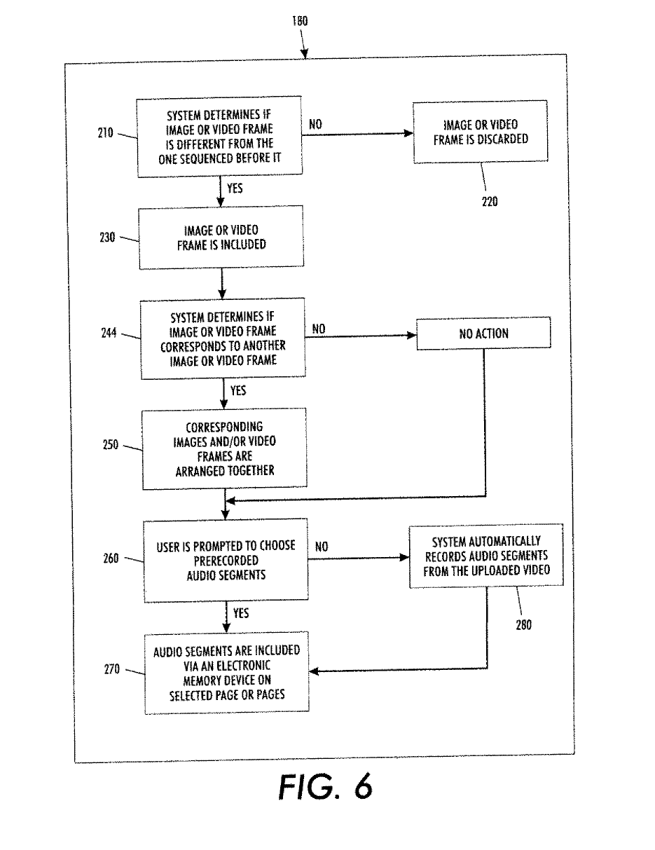

In one embodiment, as shown in FIG. 6, during the layout step 180 the system may use pattern and/or image recognition techniques now or hereafter known in the art to automatically detect images or video frames that contain only slight differences from the image or frame sequenced before it 210, and exclude those images or frames from inclusion in the book 220, so as to avoid pauses in the sequencing. If there are differences, a change in motion from the previous frame is detected, and the layout step continues with the image or video frame being included 230. In this way, each frame of video depicts a new action, and there are no unintentional duplicate snapshots 240. The system may optionally use pattern and/or image recognition techniques known in the art to recognize an image as corresponding to a sequence of video frames and vice versa 245, and automatically arrange them together in the book 250, such that common subject matter is automatically grouped together. For example, the system may recognize the video sequence of the bride and groom cutting the cake and corresponding to the snapshot of the bride and groom cutting the cake, and place them on the same page.

In one embodiment, also shown in FIG. 6, the user may choose from a selection of audio segments 260 that will be prerecorded onto one or more electronic memory devices 270 to include in the book, where the audio may correspond to each page, each image, or each book. Alternatively, the system may automatically record audio segments from the uploaded video onto one or more electronic memory devices for inclusion into the book 280. While this audio step is depicted as occurring during layout step 180, it may occur during any step of the process.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A hardcopy display comprising:
a plurality of bound pages;
a plurality of snapshots, and
a plurality of individual frames of a video sequence;
wherein the individual frames are arranged so that when the pages are flipped, the video sequence is displayed.

2. The hardcopy display of claim 1, wherein the hardcopy display comprises a book.

3. The hardcopy display of claim 1, further comprising an electronic device that plays audio.

4. The hardcopy display of claim 3, wherein the electronic device comprises an EPROM chip and sound synthesizer.

5. The hardcopy display of claim 1, wherein a plurality of the pages are cut along a width of the display to create two or more sections, each section displaying at least one of: snapshots, video sequences, and text.

6. The hardcopy display of claim 1, wherein the snapshots are displayed on pages located opposite pages that display frames from the video sequence.

7. The hardcopy display of claim 1, wherein two or more video sequences are displayed and may be viewed simultaneously.

8. A method of making a hardcopy display that displays images and video sequences on pages, the method comprising:
receiving digital images and a video sequence via an electronic communication system;
storing the digital images and video sequence onto a storage device;
receiving a selection of a location for the digital images and frames of the video sequence to be displayed on pages in a printed book;
printing the digital images and frames of the video sequence in the determined location on the pages;
binding the pages together to create the book.

9. The method of claim 8, further comprising cutting the paper before binding so that the frames are positioned substantially at edges of the pages.

10. The method of claim 8, wherein the number of images in the video sequence exceeds the number of pages to be printed in the book, and the method includes automatically selecting images from the sequence for printing in the book and automatically selecting images from the sequence that will not be printed in the book.

11. The method of claim 8, wherein the number of images in the video sequence is less than the number of pages to be printed in the book, and the method includes automatically selecting images from the sequence that will be duplicated or interpolated on successive printed pages in the book.

12. The method of claim 8, wherein the receiving a selection comprises:
automatically determining the locations;
automatically determining a size and dimension for the pages.

13. The method of claim 8, further comprising:
comparing a second video frame with a first video frame sequenced before it, and if there are no differences, excluding the second video frame from inclusion in the printed book.

14. The method of claim 8, wherein the step of determining a location further comprises:
comparing a video frame with at least one snapshot, and if there are similarities, displaying them on the same page.

15. The method of claim 8, further comprising recording at least one audio segment from the video sequence onto an electronic memory device for inclusion in the printed book.

16. A book comprising:
a first set of bound pages displaying a plurality of snapshots; and
a second set of bound pages displaying a plurality of individual frames of a first video sequence;
wherein the individual frames of the first video sequence are arranged so that when the pages of the individual frames are flipped, the first video sequence is displayed;
wherein the first video sequence may be displayed without flipping the pages of the first set.

17. The book of claim 16, further comprising a third set of bound pages displaying a plurality of individual frames of a second video sequence, wherein at least a portion of the first video sequence and second video sequence may be viewed simultaneously.

18. The book of claim 16, wherein the pages are bound with a spline.

19. The book of claim 16, wherein the frames of the first video sequence are located on pages opposite the pages containing the frames of the second video sequences and the width of the pages of the first section is different from the width of the pages of the second section.

20. The book of claim 16, wherein the first section further comprises text.
